(19) United States
(12) Patent Application Publication
(10) Pub. No.: US 2007/0007191 A1
(43) Pub. Date: Jan. 11, 2007

(54) Transfer device

(76) Inventor: Bent Larsen, Porvoo (FI)

Correspondence Address: YOUNG & THOMPSON, 745 SOUTH 23RD STREET, 2ND FLOOR, ARLINGTON, VA, 22202, US

(21) Appl. No.: 10/570,147

(22) PCT Filed: Sep. 16, 2004
(86) PCT No.: PCT/FI04/00541

§ 371 Date: Apr. 20, 2006

(30) Foreign Application Priority Data
Sep. 17, 2003 (FI) 20031327

(51) Int. Cl. B08B 7/00

(52) U.S. Cl. 210/242.4; 210/241; 210/924; 15/3

(57) ABSTRACT

A transfer device for transferring fluid includes a rope which rotates around wheels and which, moved by the wheels, comes into contact with the fluid, and a cleaner for removing fluid stuck to the rope, at least a first and a second housing provided with wheels around which the rope rotates, and at least two closed channels which are arranged between the first and second housings and into which the rope is arranged to transfer fluid from the first housing to the cleaner in the second housing.

### FIELD OF THE INVENTION

The present invention relates to a transfer device enabling fluid, e.g. oil, to be transferred effeciently from one place to another. In the following, the invention will be described by way of example with reference to oil recovery in particular, although the transfer device according to the invention can also be utilized in other connections.

### DESCRIPTION OF PRIOR ART

In sea areas, e.g. at the Gulf of Finland, the number of oil-carrying vessels has increased and the size of the vessels has increased excessively with respect to the capacity of the oil-recovery equipment available in the area. So far, in principle only oil-recovery vessels are used in offshore collecting, but in case of emergency such vessels are slow in collecting oil since the procedure is interrupted when oil is transferred away and emptied from the vessels, taking an unreasonably long time.

Vessels called offshore collectors that are self-floating and independent of oil-recovery vessels are also used. In these collectors, the collection of large amounts of oil is slowed down by the process of pumping the oil away from a vessel. Available oil pumps are incapable of pumping the collected oil further efficiently enough.

In view of the above, it would in case of emergency be advantageous to have an efficient oil transfer device to assist collecting e.g. in offshore collecting taking place in the vicinity of a shore. A need to increase efficiency becomes emphasized since it is hard to bring out any previous sizeable oil spill at sea that due to inadequate capacity for transferring the collected oil would have managed not to pollute the shores with known consequences. Here, efficiency refers to oil transfer and improvement of the technology thereof in order to alleviate the transfer of oil away from a vessel or a collector. When contemporary offshore collectors are used and when the oil transfer capacity of such vessels is to be increased, an increase in the number of pumps per collector, or larger pumps, are required, which increases power. Due to safety concerns, all oil collectors on the market invariably operate on hydraulics; consequently, the idea of large oil-collecting collectors without improving the oil transfer technology results in an oversized power demand. The ratio of the size of power units and the power demand of hydraulics to oil transfer is disproportionate. Therefore, a device is needed which transfers large amounts with a low power consumption and which enables the power demand to be reduced when the collecting capacity of a collector is increased. An object is to provide an efficient transfer technology which operates with a low power consumption and which is capable of achieving a capacity many times higher than that of the prior art. This requires a novel efficient system which by means of a low-power power source transfers large amounts in an efficient manner.

### SUMMARY OF THE INVENTION

An object if the invention is to solve the above-described problem and to provide a transfer device for enabling fluid, such as oil, to be transferred efficiently. This object is achieved by a transfer device in accordance with independent claim 1.

The present invention has revealed that by using a device comprising a rope moving in a closed channel between wheels, a low-power transfer device with high capacity is achieved. A motor is arranged in connection with at least one of the wheels that move the rope in order to provide the transfer device with a pulling force. An increase in the diameter of this drive wheel enables the speed of movement of the rope and, at the same time, the transfer capacity of the device to be increased in a simple manner.

Preferred embodiments of the transfer device according to the invention are disclosed in the attached dependent claims 2 to 7.

### BRIEF DESCRIPTION OF THE DRAWINGS

In the following, the invention will be described by way of example in closer detail with reference to the accompanying drawings, in which

FIGS. 1a to 1c show a first preferred embodiment of a transfer device according to the invention,

FIG. 2a shows the transfer device of FIGS. 1a to 1c in operation,

FIG. 3a illustrates the transfer device of FIGS. 1a to 1c in connection with an offshore collector, and

FIGS. 4a to 4b illustrate the structure of a drive wheel of the transfer device of FIGS. 1a to 1c.

### DESCRIPTION OF PREFERRED EMBODIMENTS

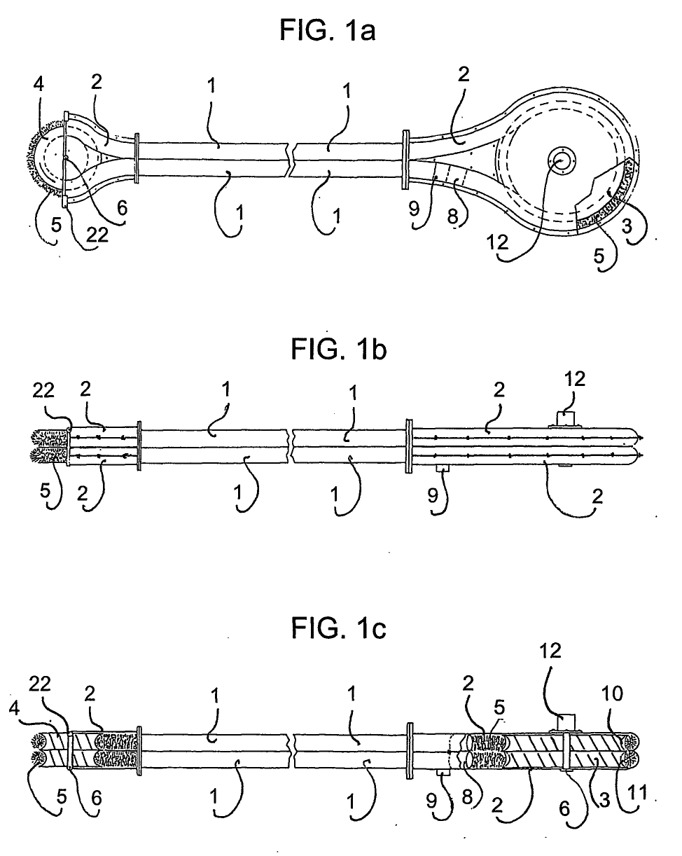

FIGS. 1a to 1c show a first preferred embodiment of a transfer device according to the invention. The figures show two transfer devices situated on top of one another. FIG. 1a is a top view of the transfer devices, FIG. 1b is a side view of the same, and FIG. 1c is a sectional side view of the transfer devices taken at protective housings.

Closed channels of the transfer devices, i.e. in this example tubes 1, are connected to protective housings 2. The protective housings 2 are built in two parts attacted to one another. In the protective housing 2 on the right in FIGS. 1a to 1c, a drive wheel 3 driven by a motor 12 is arranged on an axle 6. In the protective housing 2 on the left, in turn, a transfer wheel 4 is provided on an axle 6. Ropes 5, which are provided with bristles, rotate around the drive wheel 3 and the transfer wheel 4, transferring fluid, such as oil, from the housing on the left to a cleaner 8 provided in the housing on the right. The cleaner 8 removes fluid stuck to the ropes 5 therefrom, the removed fluid being discharged from the housing 2 on the right through a discharge opening 9. FIGS. 1a to 1c further show axles 22 of a housing of the transfer wheel.

The structure and functionality of the transfer device according to FIGS. 1a to 1c enable a high collection capacity to be achieved by means of a low power consumption. The transfer device comprises at least two housings 2 and tubes 1 or corresponding closed channels that serve both as a transfer channel and as a unit of measurement of the rope. Therefore, the rope and the tubes should be dimensioned such that there is just enough space in the tubes for the ropes that move around the wheels so that the transfer of fluid is at its most efficient.

The perimeter of the circumference of the drive wheel 3 and the rotating speed of the wheel 3 determine the speed of movement of the rope 5, and thus the transfer efficiency. Only by increasing the perimeter of the circumference of the drive wheel 3, without increasing the revoultions of the motor 12 and the diameter of the rope 5 being constant, can the capacity be increased when necessary. Thus, the drive wheel only needs a relatively low-power motor. A high capacity can thus be achieved by means of a power combination operating at a low power demand level and rotating the drive wheel 3 as the perimeter of the circumference of the drive wheel 3 pulling the rope 5 with respect to the rotating speed of the drive wheel determines the speed of movement of the rope 5, and thus the transfer efficiency.

The device utilizes housings 2 attached to both ends of two closed channels, such as a tube 1, a drive wheel 3 residing inside one of the housings and a transfer wheel 4 partly residing inside the other. In order to set the rope 5 in place, the protective housings 2 of both the drive wheel 3 and the transfer wheel 4 are assembled from two parts connected to one another. In both housings 2, both the drive wheel and the transfer wheel rotate on an axle 6. In the figures, the housing of the drive wheel is provided with a rope cleaner 8 on the path of the rope. This cleaner may be a prior art cleaner capable of removing fluid, such as oil, stuck to the bristles of the rope. The cleaner 8 may thus be e.g. of the type disclosed in U.S. Pat. No. 4,542,555, and a discharge opening 9 is provided in the housing below or next to the cleaner so that the fluid removed from the rope is allowed to be discharged from the housing.

Referring to FIGS. 1a to 1c, it has been disclosed above by way of example that a motor is necessary only in connection with a drive wheel. It is clear, however, that if necessary, a motor may also be arranged in connection with a transfer wheel 4.

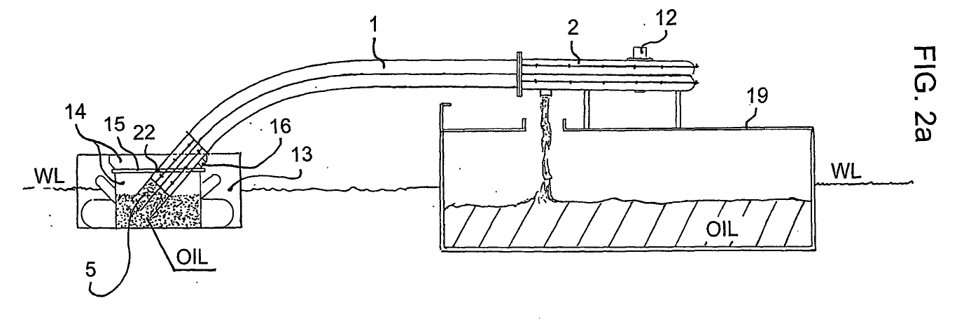

FIG. 2a shows the transfer device of FIGS. 1a to 1c in operation in connection with oil recovery. FIG. 2a shows the transfer device connected to a receiving station. One end of a rope 5 moving inside protective housings 2 connected by a tube 1 is then inserted into a tank, i.e. a well 14, of a collector 13. Empowered by a motor 12, oil is transferred along with the rope from the well 14 and discharged through a discharge opening of the transfer device to a tank 19 of the receiving station.

In such a collector 13 provided with a well 14, axles 22 to be arranged in a moving wheel 15 may be attached to a housing 2 of a transfer wheel. The housing 2 may be provided with a suspended wheel 16 to promote and smooth the movement of the tube 1 and the rope 5 in the well 14 as well as assist in carrying the weight with respect to the axle of a housing of the collector.

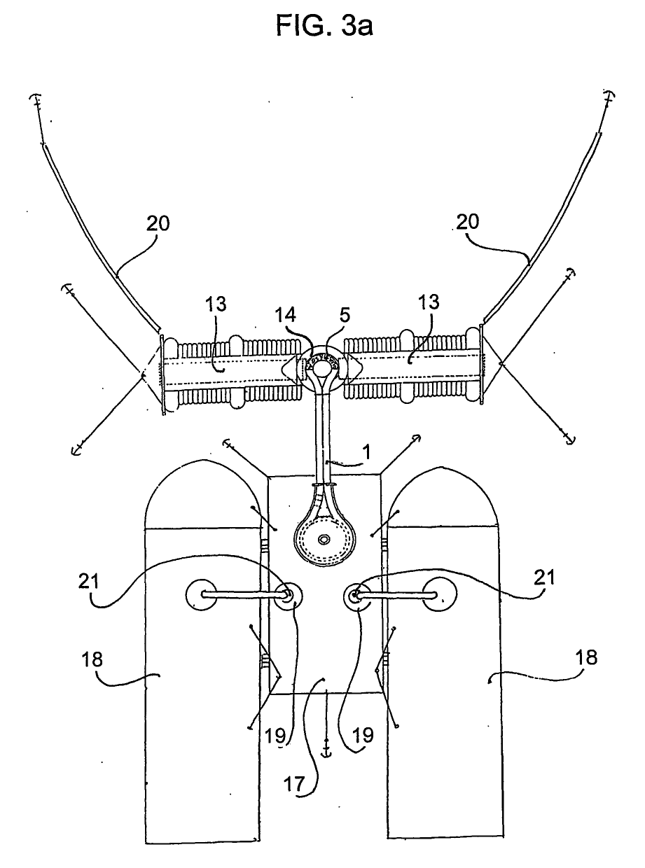

FIG. 3a illustrates the transfer device of FIGS. 1a to 1c in connection with an offshore collector 13 equipped with oil booms 20. From the anchored oil collector 13, a rope 5 of the transfer device transfers, through a tube 1, the oil collected by the oil collector to a receiving station 17. The operation takes place such that the rope 5 rotating by means of a drive wheel rotates around the transfer wheel which is arranged e.g. in a well of the collector, whereafter the rope rotating around the drive wheel starts to transfer oil from the collector through a tube to a cleaner, wherefrom the removed oil is transferred through a discharge opening to a tank 19 in the receiving station 17. Vessels 18, in turn, empty the the tanks 19 of the receiving station 17 by means of their own pumping systems 21, whereafter the vessels carry the collected oil away from the collecting place.

By using the receiving station 17, it is now possible to both collect oil in the place of damage and transfer it therefrom continuously without the collecting process being interrupted, as is the case with respect to oil-collecting vessels when the same vessels both collect oil and transfer the collected oil away. The vessels 18 transferring oil away from the receiving station 17 may thus be used for continuous transfer.

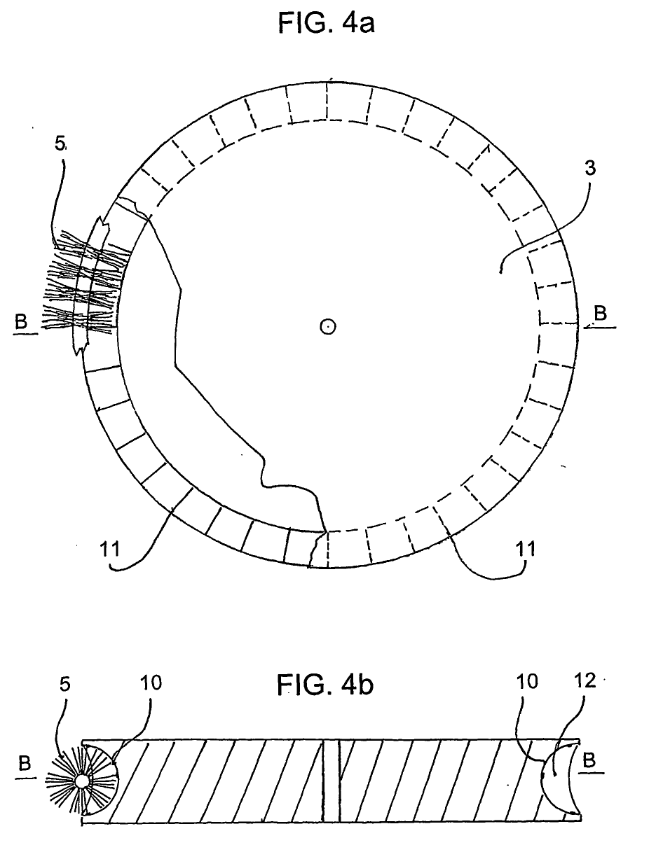

FIGS. 4a to 4b illustrate the structure of a drive wheel of the transfer device of FIGS. 1a to 1c. FIG. 4a is a top view showing the structure of the drive wheel while FIG. 4b is a side view showing the same.

The circumferential surface of the drive wheel is provided with a rim-like groove 10 which receives a rope 5 with bristles. In order to enhance the pulling force, the groove is provided with projections, which in the example of FIGS. 4a and 4b are sequentially attached, crescent-like sheet metal plates 11 or the like that extend almost to the central part of the brush rope 5 when the rope resides in the groove 10.

It is to be understood that the above description and the related drawings are only intended to illustrate the present invention. It will be obvious to one skilled in art that the invention may be varied and modified in many ways without deviating from the scope of the claims.

1-7. (canceled)

8. A transfer device for transferring fluid, the transfer device comprising:
a rope (5) which rotates around wheels (3, 4) and which, moved by the wheels, comes into contact with the fluid, a cleaner (8) for removing fluid stuck to the rope (5) therefrom;
at least a first and a second housing (2) provided with wheels (3,4) around which the rope (5) rotates; and
at least two closed channels (1) which are arranged between the first and the second housings (2) and into which the rope (5) is arranged to transfer fluid from the first housing to the cleaner in the second housing.

9. A transfer device as claimed in claim 8, wherein at least the first or the second housing is provided with a motor (12) to rotate the wheel (3) arranged in the housing in order to move the rope (5).

10. A transfer device as claimed in claim 8, wherein a circumferential surface of the drive wheel (3) is provided with a groove (10) for the rope (5).

11. An oil transfer device as claimed in claim 10, wherein in order to enhance a pulling force directed to the rope by means of the drive wheel (3), the groove (10) is provided with projections (11).

12. A transfer device as claimed in claim 11, wherein the projections (11) are made of crescent-like sheet metal plates or the like which are sequentially attached to the groove (10) and which extend to the vicinity of a central part of the rope (5) when the rope resides in the groove.

13. A transfer device as claimed in claim 8, wherein the first housing (2) is provided with an opening and fastening means (22) for mounting the housing to a tank containing fluid such that the fluid in the tank, through the opening, comes into contact with the rope (5) rotating around the wheel (4) of the first housing (2).

14. A transfer device as claimed in claim 8, wherein the first and the second housings (2) are provided with at least two coaxially arranged wheels, and a separate rope is arranged to rotate around each pair of wheels.
